(19) United States
(12) Patent Application Publication
(10) Pub. No.: US 2016/0110327 A1
(43) Pub. Date: Apr. 21, 2016

(54) TEXT CORRECTION BASED ON CONTEXT

(71) Applicant: Lenovo (Singapore) Pte. Ltd., Singapore (SG)

(72) Inventor: Jonathan Gaither Knox, Morrisville, NC (US)

(21) Appl. No.: 14/518,547

(22) Filed: Oct. 20, 2014

(51) Int. Cl. G06F 17/24

(52) U.S. Cl. CPC G06F 17/24

(57) ABSTRACT

An embodiment provides a method, including: accessing, using a processor of an electronic device, a data store; determining, using a processor, a predetermined context based on the data store; receiving, at an input device of the electronic device, a user text input; analyzing, using a processor, the user text input based on the predetermined context; and offering, using a processor, a suggested modification of the user text input based on the predetermined context. Other aspects are described and claimed.

### BACKGROUND

Information handling devices (“devices”), for example cell phones, smart phones, tablet devices, laptop and desktop computers, and the like, utilize input devices (keyboards, touch screens, microphones, cameras, or combinations of these devices) to allow users to provide inputs, e.g., text inputs for a word processing application, an email or other messaging application, etc.

Conventionally, user text inputs undergo an automated examination, e.g., a spelling and grammar check is provided. Moreover, some systems provide automated suggestions for users, e.g., suggesting a word based on the first few characters typed.

By way of example, a typical system will offer to correct (or simply autocorrect) common misspellings or attempt to correct or suggest corrections for common spelling or grammar errors, e.g., “they're” versus “their” and the like. Some systems or sub-systems (e.g., soft keyboards and associated logic) offer suggestions based on past user inputs, e.g., stored preferred words, commonly used words, etc. In this way, the system can learn preferred words of the users and offer these as suggestions such that the user need only type the first few characters in order for the suggestion to be made.

### BRIEF SUMMARY

In summary, one aspect provides a method, comprising: accessing, using a processor of an electronic device, a data store; determining, using a processor, a predetermined context based on the data store; receiving, at an input device of the electronic device, a user text input; analyzing, using a processor, the user text input based on the predetermined context; and offering, using a processor, a suggested modification of the user text input based on the predetermined context.

Another aspect provides a device, comprising: an input device; a sensor; a processor operatively coupled to the input device and the sensor; and a memory operatively coupled to the processor that stores instructions executable by the processor, the instructions comprising: instructions that access a data store; instructions that determine a predetermined context based on the data store; instructions that receive, at the input device, a user text input; instructions that analyze the user text input based on the predetermined context; and instructions that offer a suggested modification of the user text input based on the predetermined context.

A further aspect provides a program product, comprising: a storage device having program code embodied therewith, the program code being executable by a processor and comprising: program code that accesses a data store; program code that determines a predetermined context based on the data store; program code that receives, at an input device of the electronic device, a user text input; program code that analyzes the user text input based on the predetermined context; and program code that offers a suggested modification of the user text input based on the predetermined context.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device.

FIG. 2 illustrates another example information handling device.

FIG. 3 illustrates an example method of text correction based on context.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While prior systems are adequate for correcting common misspellings and common grammatical errors, in many cases conventional systems fail to give users the type of suggestions that are truly helpful. For example, conventional systems fail to distinguish that a correctly spelled work is misplaced or misused, such as in the phrase “He is a good principle.” Here, “principle” is spelled correctly, but the correct usage is “principal,” which conventional systems will not recognize.

Accordingly, an embodiment utilizes context for auto-correction and/or suggested modifications. For example, in a document (e.g., word processing document, email message, etc.) about breakfast, a user input of “serial” may be corrected to “cereal” by virtue of contextual knowledge and inferences, e.g., that the relevant topic is breakfast or morning, each of which is associated with the word “cereal” and not with the word “serial.”

The illustrated example embodiments will be best understood by reference to the figures. The following description is intended only by way of example, and simply illustrates certain example embodiments.

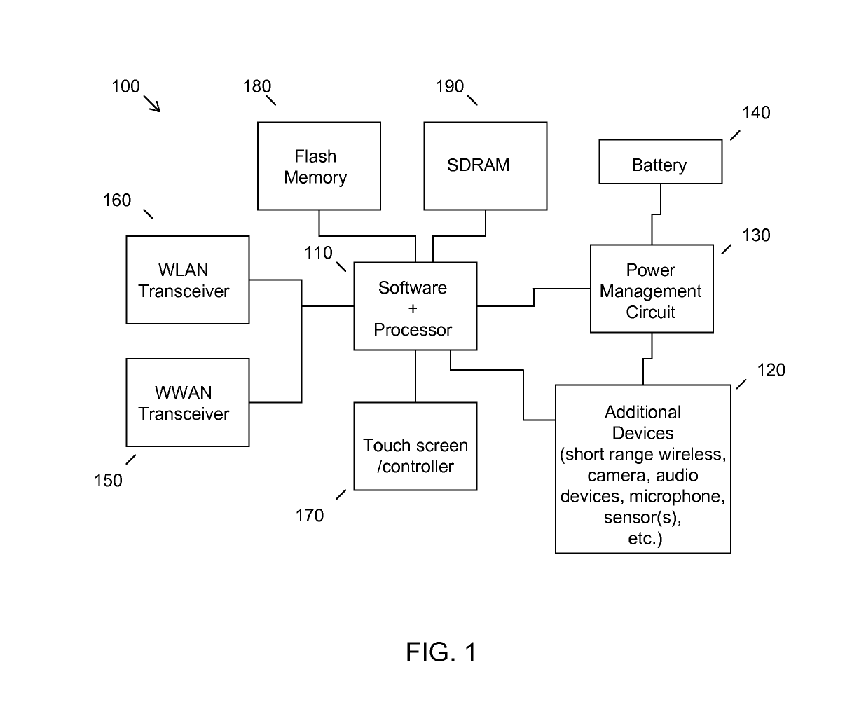

While various other circuits, circuitry or components may be utilized in information handling devices, with regard to smart phone and/or tablet circuitry 100, an example illustrated in FIG. 1 includes a system design found for example in tablet or other mobile computing platforms. Software and processor(s) are combined in a single unit 110. Internal busses and the like depend on different vendors, but essentially all the peripheral devices (120) may attach to a single unit 110. The circuitry 100 combines the processor, memory control, and I/O controller hub all into a single unit 110. Also, systems 100 of this type do not typically use SATA or PCI or LPC. Common interfaces for example include SDIO and I2C.

There are power management circuits(s) 130, e.g., a battery management unit, BMU, which manage power as supplied for example via a rechargeable battery 140, which may be recharged by a connection to a power source (not shown). In at least one design, a single unit, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. Additional devices may include short range wireless radio(s), such as BLUETOOTH radios, for communicating with other devices. Near field communication element(s) may also be included as additional device(s) 120. Commonly, system 100 will include a touch screen/controller 170 for data input and display. System 100 also typically includes various memory devices, for example flash memory 180 and SDRAM 190.

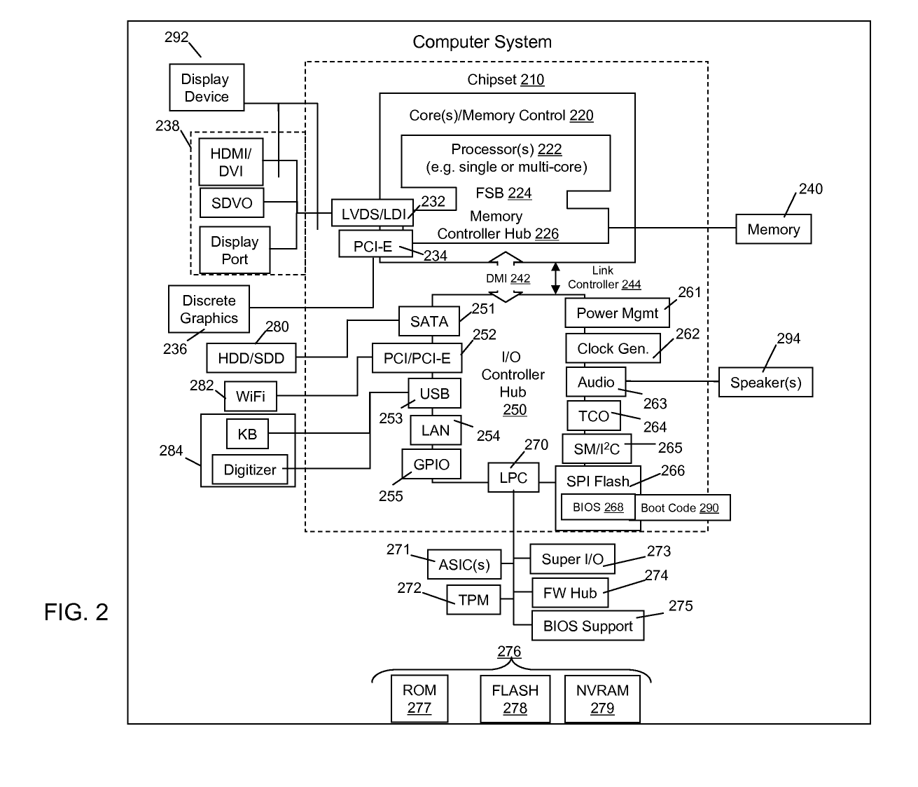

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a set 210 (a group of integrated circuits that work together) with an architecture that may vary depending on manufacturer (for example, INTEL, AMD, ARM, etc.). INTEL is a registered trademark of Intel Corporation in the United States and other jurisdictions. AMD is a registered trademark of Advanced Micro Devices, Inc. in the United States and other jurisdictions. ARM is a trademark of ARM Holdings plc in various jurisdictions.

The architecture of the set 210 includes a core and memory control group 220 and an I/O controller hub 250 that exchanges information (for example, data, signals, commands, etc.) via a direct management interface (DMI) 242 or a link controller 244. In FIG. 2, the DMI 242 is an interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a unit that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280, etc.), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones and/or other devices with which a user provides inputs, e.g., to a touch screen, a keyboard, a microphone, etc. These inputs may include user text inputs (e.g., character inputs via a keyboard or word inputs converted to machine text).

As described herein, an embodiment intelligently analyzes contextual data in an effort to augment and improve auto-correction and suggested modifications for the user text inputs. An embodiment may obtain contextual data from a variety of sources, both locally and remotely (e.g., a remote/off device store of contextual data).

For example, an embodiment may derive contextual data from prior user inputs, e.g., within the same sentence or phrase, from the same paragraph of document element (input field, bullet point, list, etc.), from a title of the document or message, from the application which is being used, from a file name, etc. Likewise, contextual data may be derived from sensed data, e.g., location data, time data, movement data, voice or gesture data, combinations of these, etc.

With these various sources of contextual data, an embodiment may determine a context during which a user has provided text input. For example, in a document, a first sentence may include the following user input: “This morning I was hungry.” The following user input may next be received: “So I decided to eat some serial.” In this example, a conventional system would not ascertain that there is a potential problem with the word “serial” in the second sentence, as contextual data is not utilized.

However, an embodiment may examine the prior inputs, in this example “morning” and “hungry” may map, e.g., in a taxonomy or other topical hierarchy, to a topic of “breakfast.” For example, a topical hierarchy may include “morning” and/or “hungry” as a child node of parent node “breakfast.” If the hierarchy includes “cereal” as another child node of the parent “breakfast,” this permits an embodiment to infer that the correct word might be “cereal” instead of “serial,” as these words are known to be homonyms, and to suggest the same as a modification to the user.

Other contextual data may enhance this resolution, e.g., impart weighting on a particular word's score or confidence level. By way of example, a sensor such as a integral clock offering a current local time, e.g., 7:30 a.m., might provide data used by an embodiment to enhance the confidence that “cereal” is the intended word, rather than “serial.” Other sensors and contextual data may also be used.

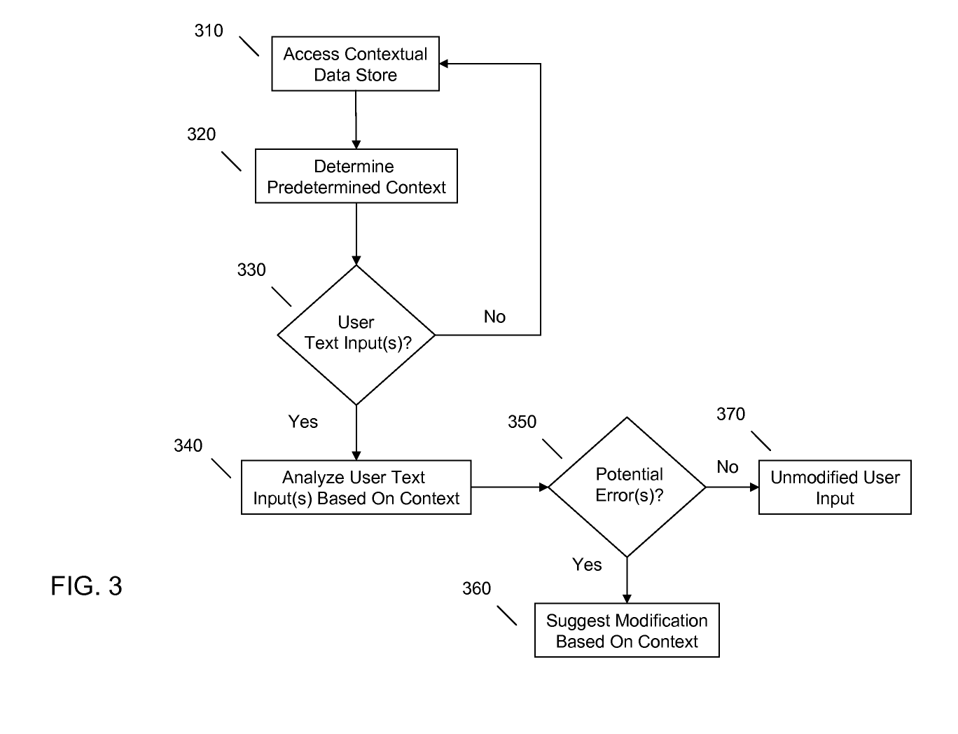

Referring now to FIG. 3, an example method of correction or suggestion using context is illustrated. As may be appreciated, an embodiment may access a contextual data store at 310. The contextual data store may include raw data, e.g., recently received user inputs and/or processed data, e.g., user inputs mapped to nodes within a hierarchy, a topic or context associated or selected via that mapping, etc., as described herein.

This permits an embodiment to determine a predetermined context at 320. That is, an embodiment may intelligently infer a context or background for assistance in interpreting further inputs. As in the previous example, an embodiment may use prior user text inputs, local time, etc., to determine that the context is “morning” or “breakfast” given a collection of contextual data, e.g., stored in a contextual data store.

If a user then inputs text, e.g., at 330, an embodiment may evaluate the user input in terms of its contextual background. By way of example, a user input of text, e.g., “serial” received at 330 may be analyzed at 340 not simply for correct spelling at 340, but also on the basis of context. That is, an embodiment may analyze the input “serial” at 340 in terms of the context, e.g., derived from the contextual data store.

In this way, an embodiment may determine if there is a potential error in the input at 350. By way of example, an embodiment may score the word in terms of confidence level with respect to appropriateness based on the context. Here, the word “serial” may be given a low score considering the word “serial” many have no relation or association with the context of “morning” or “breakfast,” etc. As may be appreciated, a variety of scoring systems may be utilized, as may a variety of different hierarchies or other contextual data information.

If an embodiment determines that there is a potential problem at 350, e.g., the given user input has a low score (e.g., below a predetermined threshold), an embodiment may suggest a modification at 360. Otherwise, an embodiment may input the text without modification or suggestion. The modification may include auto-correction, e.g., if another word, e.g., “cereal” is known to be of particularly high score, e.g., a homonym of “serial” and a word included as a child leaf of “breakfast.”

Thus, an embodiment may access, using a processor of an electronic device, a contextual data store at 310, determine a predetermined context based on the contextual data store at 320, and thereafter receive, at an input device of the electronic device, a user text input at 330. An embodiment may then analyze the user text input at 340 based on the predetermined context and, if deemed appropriate at 350, offer a suggested modification of the user text input based on the predetermined context at 360.

As described herein, the contextual data store may be populated with data received previously from the user, e.g., one or more user text inputs received at an input device of an electronic device. This permits an embodiment to associate a word of the one or more text inputs with a predetermined topic within a hierarchy and store, in the contextual data store, contextual data derived from the one or more user text inputs.

By way of example, the accessing of the contextual data store at 310 may comprise accessing contextual data derived from the one or more user text inputs, and the determining a predetermined context at 320 may comprise selecting an active predetermined topic based on the contextual data derived from the one or more user text inputs. This may be done periodically, intermittently, or continuously.

As has been described, other sources of contextual data may aid in the analysis of the context and selection of an active topic or predetermined context. For example, one or more sensor inputs may be associated with a predetermined topic within a hierarchy. As will be appreciated by those having skill in the art, a variety of sensors and related inputs may prove useful in such an analysis, e.g., a microphone input, a global positioning satellite system input, a wireless network derived input, and an accelerometer input, etc.

In an embodiment, the predetermined context may include a topic associated with prior user inputs in an active input session. Thus, an embodiment may select a topic for a given user input session, such as when a user begins typing into a word processing document. This predetermined topic or context may then be updated according to a policy, e.g., intermittently, in response to a given amount of input, continuously, etc.

This permits an embodiment to utilize an additional or different form of scoring with respect to inputs. This allows an embodiment to offer suggestions and modifications in many instances where conventional systems fail, e.g., for correctly spelled words that are misused or misplaced.

As will be appreciated by one skilled in the art, various aspects may be embodied as a system, method or device program product. Accordingly, aspects may take the form of an entirely hardware embodiment or an embodiment including software and hardware that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication or short range wireless communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of an information handling device or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accessing, using a processor of an electronic device, a data store;
determining, using a processor, a predetermined context based on the data store;
receiving, at an input device of the electronic device, a user text input;
analyzing, using a processor, the user text input based on the predetermined context; and
offering, using a processor, a suggested modification of the user text input based on the predetermined context.

2. The method of claim 1, further comprising:
receiving, at an input device of an electronic device, one or more user text inputs;
associating a word of the one or more text inputs with a predetermined context; and
storing, in the data store, contextual data derived from the one or more user text inputs.

3. The method of claim 2, wherein;
the accessing the data store comprises accessing contextual data derived from the one or more user text inputs; and
the determining a predetermined context comprises selecting an active predetermined topic based on the contextual data derived from the one or more user text inputs.

4. The method of claim 1, further comprising:
receiving, at the electronic device, one or more sensor inputs;
associating the one or more sensor inputs with a predetermined context; and
storing, in the data store, contextual data derived from the one or more sensor inputs.

5. The method of claim 4, wherein;
the accessing the data store comprises accessing contextual data derived from the one or more sensor inputs; and
the determining a predetermined context comprises selecting an active predetermined context based on the contextual data derived from the one or more sensor inputs.

6. The method of claim 5, wherein the one or more sensor inputs are selected from the group of sensor inputs consisting of: a microphone input, a global positioning satellite system input, a wireless network derived input, and an accelerometer input.

7. The method of claim 1, wherein the offering comprises an automated change to the user text input.

8. The method of claim 1, wherein the suggested modification comprises a spelling modification.

9. The method of claim 1, wherein the suggested modification comprises a word form change.

10. The method of claim 9, wherein the word form change comprises a homonym.

11. A device, comprising:
an input device;
a sensor;
a processor operatively coupled to the input device and the sensor; and
a memory operatively coupled to the processor that stores instructions executable by the processor, the instructions comprising:
instructions that access a data store;
instructions that determine a predetermined context based on the data store;
instructions that receive, at the input device, a user text input;
instructions that analyze the user text input based on the predetermined context; and
instructions that offer a suggested modification of the user text input based on the predetermined context.

12. The device of claim 11, wherein the instructions further comprise:
instructions that receive, at the input device, one or more user text inputs;
instructions that associate a word of the one or more text inputs with a predetermined context; and
instructions that store, in the data store, contextual data derived from the one or more user text inputs.

13. The device of claim 12, wherein;
to access the data store comprises accessing contextual data derived from the one or more user text inputs; and
to determine a predetermined context comprises selecting an active predetermined topic based on the contextual data derived from the one or more user text inputs.

14. The device of claim 11, wherein the instructions further comprise:
instructions that receive one or more sensor inputs;
instructions that associate the one or more sensor inputs with a predetermined context; and
instructions that store, in the data store, contextual data derived from the one or more sensor inputs.

15. The device of claim 14, wherein;
to access the data store comprises accessing contextual data derived from the one or more sensor inputs; and
to determine a predetermined context comprises selecting an active predetermined context based on the contextual data derived from the one or more sensor inputs.

16. The device of claim 15, wherein the one or more sensor inputs are selected from the group of sensor inputs consisting of: a microphone input, a global positioning satellite system input, a wireless network derived input, and an accelerometer input.

17. The device of claim 1, wherein to offer comprises an automated change to the user text input.

18. The device of claim 11, wherein the suggested modification comprises a spelling modification.

19. The device of claim 11, wherein the suggested modification comprises a word form change.

20. A program product, comprising:
a storage device having program code embodied therewith, the program code being executable by a processor and comprising:
program code that accesses a data store;
program code that determines a predetermined context based on the data store;
program code that receives, at an input device of the electronic device, a user text input;
program code that analyzes the user text input based on the predetermined context; and
program code that offers a suggested modification of the user text input based on the predetermined context.
